(19) United States
(12) Patent Application Publication
(10) Pub. No.: US 2022/0109279 A1
(43) Pub. Date: Apr. 7, 2022

(54) CIRCULAR CONNECTOR ALIGNMENT TOOL

(71) Applicant: Mark Schilling, St. Louis, MO (US)

(72) Inventor: Mark Schilling, St. Louis, MO (US)

(21) Appl. No.: 17/490,886

(22) Filed: Sep. 30, 2021

Related U.S. Application Data
(60) Provisional application No. 63/087,426, filed on Oct. 5, 2020.

(51) Int. Cl. H01R 43/26

(52) U.S. Cl. CPC H01R 43/26

(57) ABSTRACT

Provided is a tool for aligning a circular connector. Also provided is a method of aligning a circular connector.

### CROSS-REFERENCE TO RELATED APPLICATIONS

This application claims the benefit of U.S. Provisional Application No. 63/087,426, filed Oct. 5, 2020, and incorporated by reference herein in its entirety.

### BACKGROUND OF THE INVENTION

### (1) Field of the Invention

The present application generally relates to electrical connections. More specifically, this application provides a tool that assists in the alignment of pins in a male electrical connector with sockets in a female electrical connector when an alignment indicator in one of the connectors fail.

### (2) Description of the Related Art

In certain electrical connectors, for example round connectors used in stage lighting, the connectors are normally aligned by a notch in the ring around the sockets of the female connector and a matching protrusion in the ring around the pins of the male connector. An insert in the connector often has a second protrusion that matches a notch on the inside shell of the connector or is glued into place during manufacturing. These keying methods sometimes fail, making alignment of the male and female connectors difficult. The tool of the present invention is designed to align the pins or sockets of the failed connector in the proper position long enough to either re-glue the connector or to allow the user to add an extension with an undamaged connector.

### BRIEF SUMMARY OF THE INVENTION

The present invention is directed to a tool for aligning a circular connector when the connector fails such that indicator notches or protrusions in an outer ring of the connector is no longer immobilized relative to the connector protrusions.

Thus, in some embodiments, a tool for aligning a circular connector is provided. In these embodiments, the circular connector comprises multiple pins (male connector) or sockets (female connector) in a configuration, where the pins or sockets have a set length. The tool comprises a component comprising cavities arranged in the configuration, where the component can fit into the circular connector.

Also provided is a method of aligning a circular connector, where the connector has failed as described above. The method comprises inserting the above tool into the connector and rotating the connector into alignment with the tool.

### BRIEF DESCRIPTION OF THE SEVERAL VIEWS OF THE DRAWINGS

FIG. 1 is a photograph of a front view of a male 19 pin connector.

FIG. 2 is a photograph of a front view of a female 19 pin connector.

FIG. 3 is a front view of an exemplary tool of the present invention.

FIG. 4 is a transparent view of an exemplary tool of the present invention.

### DETAILED DESCRIPTION OF THE INVENTION

In some embodiments, a tool for aligning a circular connector is provided. In these embodiments, the circular connector comprises multiple pins (male connector) or sockets (female connector) in a configuration, where the pins or sockets having a set length. The tool comprises a component comprising cavities arranged in the configuration, where the component can fit into the circular connector.

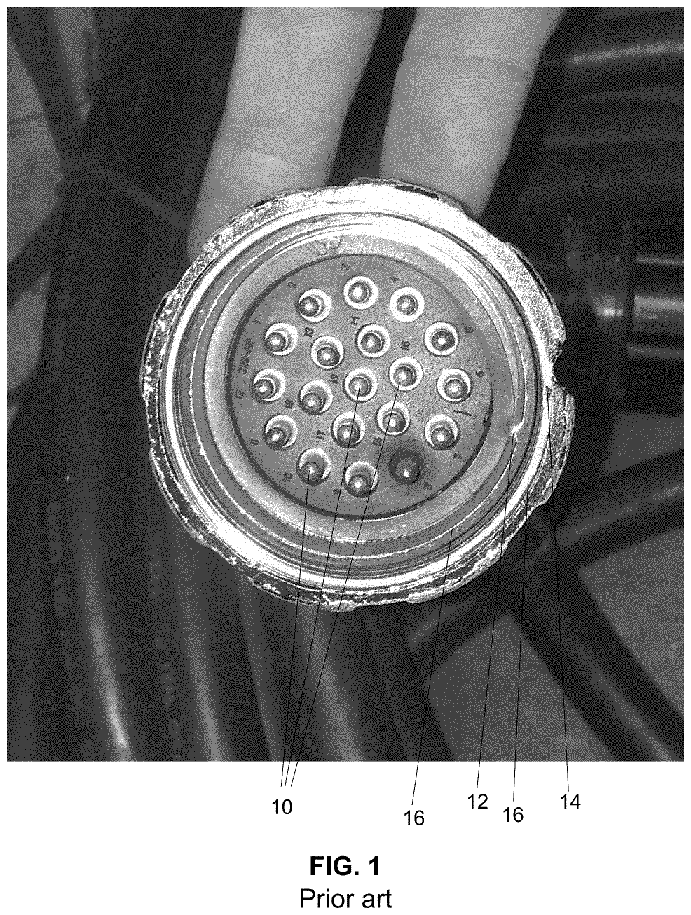

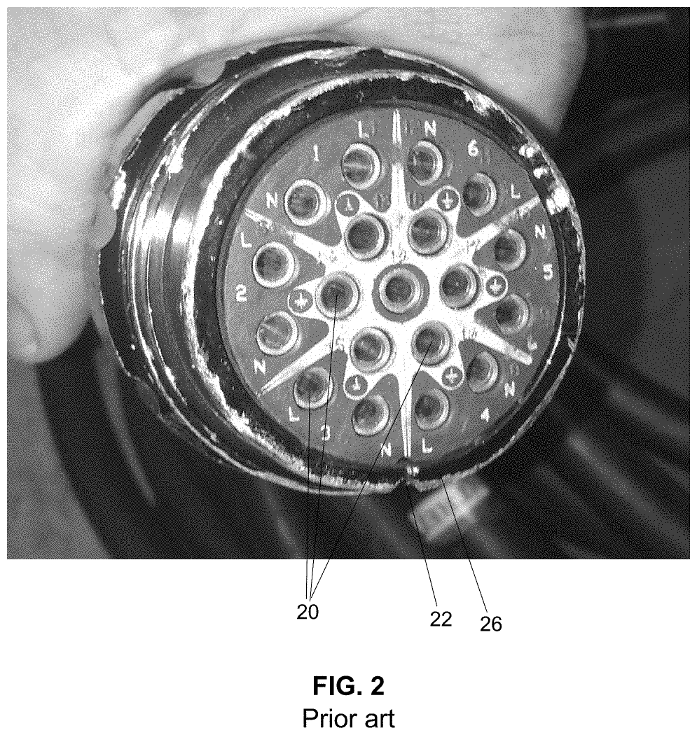

An example of a connector for which the invention tool is useful is the 19-pin connector shown in FIG. 1, showing pins 10, a protrusion 12 on an inner ring 16 and a notch 14 on an outer ring 18. The protrusion and notch are used to guide the user as to the orientation of the pins. In some connectors, the notch on the outer ring is replaced with a protrusion. Similarly, FIG. 2 shows a 19-pin female connector compatible with the male connector of FIG. 1. Sockets 20 and a notch 22 on a ring 26 are shown.

The component can have any shape and can have any number of cavities in the configuration of the circular connector. For example, the tool can have only one cavity, provided the component can fit into the connector such that the cavity aligns with a pin or socket of the connector. In some embodiments, the tool has more than one cavity, e.g., 2, 3, 4, 5, 6, 7, 8, 9, 10, 11, 12, 13, 14, 15, 16, 17, 18, 19, or more cavities in the configuration of some or all of the pins or sockets of the connector. In some of these embodiments, the component has the same number of cavities as the connector has pins or sockets. The configuration of the cavities in the tool can take the configuration of any circular connector, e.g., a standard connector with 4, 5, 6, 7, 8, 12, 16 or 19 pins or sockets. In some embodiments, the connector has 19 pins or sockets.

The component can have any shape that will fit into the connector, provided that (a) the component has at least one cavity that, when the component is inserted into a male connector, a connector pin enters into the cavity; and (b) when inserted into the connector, the component can be rotated to rotate the connector pins relative to the outer ring(s) of the connector. In some embodiments, the component is round, with a diameter smaller than a circular insert portion of the connector encompassing the pins or sockets. In some of those embodiments, the round component fits just inside the connector and has a cavity that corresponds, and fits over, each pin of the connector.

The component can be of any thickness that allows it to be inserted into the connector and turned to align the pins or sockets. In some embodiments, the component thickness is nearly the length of the pins, the length of the pins, or greater than the length of the pins.

To use the component on a female connector, the tool can further comprise at least one insert that fits into the cavities in the component such that, when the inserts are in the cavities of the component, the component fits into a female connector such that the inserts are inside the sockets of the connector.

The inserts can be of any configuration that would serve that purpose. In some embodiments, the inserts are shafts with a diameter equal to or less than the male pins and long enough to protrude from a cavity when inserted therein. In some embodiments, for example where the cavities pass completely through the component (i.e., are as long as the thickness of the component), the inserts have a shoulder preventing them from passing through the component. In other embodiments, the inserts are joined together to form at least a portion of the configuration.

In some embodiments, the tool further comprises a handle joined to the component. The handle can be of any size or shape that allows it to be held to insert the component into the connector. In some embodiments, the handle is thinner than the component.

In various embodiments, the tool further comprises at least one external notch or protrusion in the component that, when the tool is inserted into the connector, aligns with a protrusion or notch in an outer shell of the connector. In some of these embodiments, the tool comprises a set of more than one external notches in the component that, when the tool is inserted into the connector, aligns visually with a protrusion or notch in an outer shell of the connector. As is known, the protrusion or notch in the outer shell of many connectors is in a fixed relationship to at least one key pin or socket of the connector. For example, many 19 pin connectors comprise at least two key pins or sockets at pins designated one and twelve.

The present invention is also directed to a method of aligning a circular connector, where the connector has failed as described above. The method comprises inserting the above tool into the connector and rotating the connector into alignment with the tool.

In some of these embodiments, the connector is a male connector. In other embodiments, the connector is a female connector, and the tool has inserts in cavities of the connector as described above.

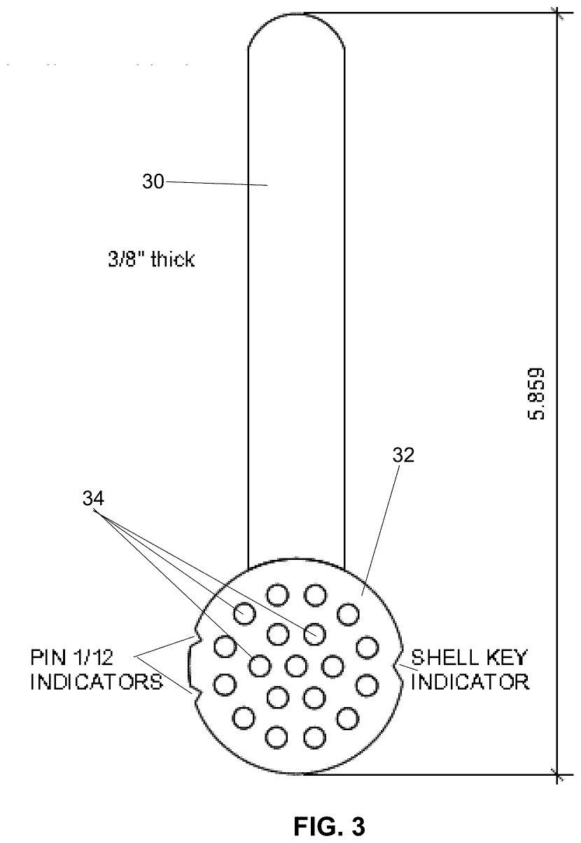

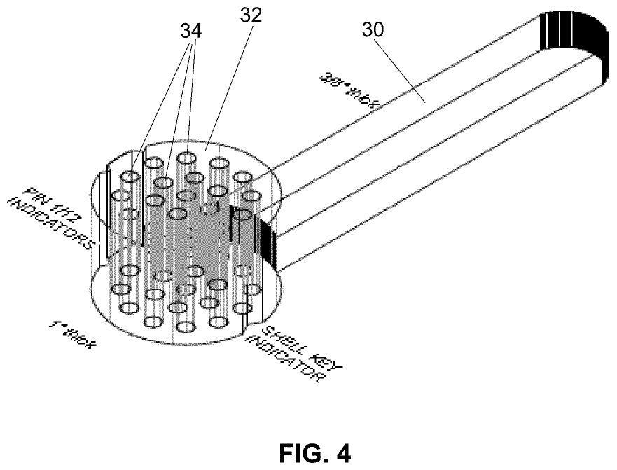

A non-limiting example of a tool of the present invention is provided in FIGS. 3 and 4. FIG. 3 is a front view and FIG. 4 is a transparent view of the exemplary tool, showing the handle 30, the component 32 with cavities 34 and notches indicating pins 1 and 12, and the shell key, which aligns with a notch in the outer ring of the connector. In this example, the cavities pass completely through the component.

In view of the above, it will be seen that several objectives of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification, including but not limited to patent publications and non-patent literature, are hereby incorporated by reference. The discussion of the references herein is intended merely to summarize the assertions made by the authors and no admission is made that any reference constitutes prior art. Applicants reserve the right to challenge the accuracy and pertinence of the cited references.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

What is claimed is:

1. A tool for aligning a circular connector, the circular connector comprising multiple pins (male connector) or sockets (female connector) in a configuration, the pins or sockets having a set length,
the tool comprising a component comprising cavities arranged in the configuration, wherein the component can fit into the circular connector.

2. The tool of claim 1, wherein the component thickness is nearly the length of the pins or greater.

3. The tool of claim 1, wherein the component is round, with a diameter smaller than a circular insert portion of the connector encompassing the pins or sockets.

4. The tool of claim 1, further comprising a handle joined to the component.

5. The tool of claim 4, where the handle is thinner than the component.

6. The tool of claim 1, wherein the connector has 4, 5, 6, 7, 8, 12, 16 or 19 pins or sockets.

7. The tool of claim 1, wherein the connector has 19 pins or sockets.

8. The tool of claim 1, further comprising more than one insert that fits into the cavities in the component, wherein, when the inserts are in the cavities of the component, the component fits into a female connector such that the inserts are inside the sockets of the connector.

9. The tool of claim 8, wherein the inserts are shafts with a shoulder preventing them from passing through the component, with a diameter equal to or less than the male pins, and long enough to pass through the component and partway into the sockets.

10. The tool of claim 8, wherein the inserts are joined together to form at least a portion of the configuration.

11. The tool of claim 1, further comprising at least one external notch in the component that, when the tool is inserted into the connector, aligns with a protrusion or notch in an outer shell of the connector.

12. The tool of claim 11, comprising a set of more than one external notches in the component that, when the tool is inserted into the connector, aligns visually with a protrusion or notch in an outer shell of the connector.

13. The tool of claim 12, wherein the protrusion in the outer shell of the connector is in a fixed relationship to at least one key pin or socket of the connector.

14. The tool of claim 13, wherein the connector is a 19-pin connector comprising at least two key pins or sockets, wherein the at least two key pins or sockets are designated pins one and twelve.

15. A method of aligning a circular connector, the method comprising inserting the tool of claim 1 into the connector and rotating the connector into alignment with the tool.

16. The method of claim 1, wherein the connector is a male connector.

17. The method of claim 1, wherein the connector is a female connector, and the tool comprises inserts in cavities of the connector.
